(19) United States
(12) Patent Application Publication
(10) Pub. No.: US 2025/0139142 A1
(43) Pub. Date: May 1, 2025

(54) LARGE LANGUAGE MACHINE LEARNING MODELS FOR SERVICE PROVIDER VIRTUAL COMMUNICATION SYSTEMS

(71) Applicant: Predii, Inc., Palo Alto, CA (US)

(72) Inventors: Tilak B. Kasturi, Palo Alto, CA (US); Azaruddin Papalal Jodatti, Karnataka (IN); Abhishek Kumar, Pune (IN)

(73) Assignee: Predii, Inc., Palo Alto, CA (US)

(21) Appl. No.: 18/927,838

(22) Filed: Oct. 25, 2024

Related U.S. Application Data
(60) Provisional application No. 63/592,926, filed on Oct. 25, 2023.

(51) Int. Cl. G06F 16/334; G06F 16/3329; G06F 40/295; G06F 40/58

(52) U.S. Cl. CPC G06F 16/3347; G06F 16/3329; G06F 40/295; G06F 40/58

(57) ABSTRACT

In one embodiment, a method of training one or more artificial intelligence (AI) models for language-based communication prompts with a service provider is disclosed. The training method includes generating industry specific labels used to fine tune a large language model; providing an industry specific database associated with the industry specific labels to fine tune the large language model; reading the industry specific database into the large language model; adjusting the parameters of the large language model to recognize industry specific terms associated with servicing equipment within the industry; adjusting the parameters of the large language model to discover the intent associated with the industry specific terms; and adjusting the parameters of the large language model for industry specific tasks including questions and answer tasks, named entity recognition, classification tasks, and machine translations tasks.

### CROSS-REFERENCE TO RELATED APPLICATIONS

This patent application claims the benefit of U.S. Provisional Patent Application No. 63/592,926 titled “LARGE LANGUAGE MACHINE LEARNING MODELS FOR VIRTUAL COMMUNICATION WITH SERVICE PROVIDERS” filed on Oct. 25, 2023, by inventors Tilak B. Kasturi et al., for all intents and purposes. If there are inconsistencies, this document will be controlling.

This patent application incorporates by reference U.S. patent application Ser. No. 16/601,525 titled “ADAPTABLE SYSTEMS AND METHODS FOR DISCOVERING INTENT FROM ENTERPRISE DATA” filed on Oct. 14, 2019 by inventors Tilak B. Kasturi et al., for all intents and purposes, now issued as U.S. patent Ser. No. 11/741,384; and also incorporates by reference U.S. patent application Ser. No. 14/533,085 entitled “ADAPTABLE SYSTEMS AND METHODS FOR PROCESSING ENTERPRISE DATA” filed on Nov. 4, 2014 by inventors Tilak B. Kasturi et al., for all intents and purposes, now issued as U.S. patent Ser. No. 10/157,347.

### COPYRIGHT/TRADEMARK NOTICE

A portion of the disclosure of this patent document contains material to which a claim for copyright and trademark is made. The copyright and trademark owner has no objection to the reproduction of the patent document or the patent disclosure, as it appears in the U.S. Patent Office records, but reserves all other copyright and trademark rights whatsoever.

### FIELD

The disclosed embodiments relate generally to large language models for machine learning of virtual systems support in service industries.

### BACKGROUND

Large language models (LLMs) for machine learning are known for translating words and sentences from one spoken language into another. LLMs, such as CHATGPT, are also known for generating text output in response to a short text prompt input or request. The LLMs have to be trained to provide a desired output with a large database of text. It is desirable for new applications of LLMs be introduced in order to improve services and benefit society.

### BRIEF SUMMARY

The embodiments are summarized by the claims that follow below. But briefly, in some aspects, the techniques described herein relate to a method for communicating with a service provider using language-based communication and one or more artificial intelligence (AI) models, the method including: receiving an input prompt requesting domain specific information regarding servicing equipment within an industry; determining (calculating, logically determining) an initial output response using an industry specific large language machine learning model periodically and dynamically fined tuned with an industry specific language database; and outputting the initial output response to an interface. In some aspects, the techniques described herein relate to a method for communicating, wherein: the interface is an application programmable interface. In some aspects, the techniques described herein relate to a method for communicating, further including generating follow up questions based on the prompt, the initial output response, and the industry specific large language machine learning model; and outputting the follow up questions to the interface. In some aspects, the techniques described herein relate to a method for communicating, wherein: the input prompt is provided by a user; and the interface is accessible to the user to receive the initial output response. In some aspects, the techniques described herein relate to a method for communicating, wherein: the interface is an output device accessible to the user. In some aspects, the techniques described herein relate to a method for communicating, wherein: the output device is a display device; and the response is displayed to the user on the display device.

In some aspects, the techniques described herein relate to a method for training and fine tuning one or more artificial intelligence (AI) models for language-based communication (prompts) with a service provider, the method including: generating industry specific labels used to fine tune a large language model; providing an industry specific database associated with the industry specific labels to fine tune the large language model; reading the industry specific database into the large language model; adjusting the parameters of the large language model to recognize industry specific terms associated with servicing equipment within the industry; adjusting the parameters of the large language model to discover the intent associated with the industry specific terms; and adjusting the parameters of the large language model for industry specific tasks including questions and answer tasks, named entity recognition, classification tasks, and machine translations tasks.

In some aspects, the techniques described herein relate to a system for analyzing language-based prompts related to servicing equipment, the system including: a vector database storing word embedding vectors associated with selected service data of the equipment (United States national highway traffic safety administration (NHTSA) complaints data base, NHTSA technical service bulletins data base, NHTSA recalls database, prior repair orders of equipment database including customer support data, technician documents database, technical service manuals database); a large language tasks module coupled in communication with the vector database and an interface, the tasks module to receive one or more input prompts from the interface, the large language task module having industry specific tasks including questions and answer tasks, named entity recognition (symptom component, symptom, failure component, failure, repair component, repair), classification tasks (symptom component, symptom, failure component, failure, repair component, repair, symptom to repair correlation, symptom to failure correlation, top symptoms, top repairs, etc.), and machine translations tasks, the large language tasks module receives the one or more input prompts, performs intent discovery, generates an updated prompt request based on the one or more input prompts; a fine-tuned large language AI model coupled in communication with the large language tasks, the fine-tuned large language AI model receives the updated prompt request and process the updated prompt request and generates an output response based on the updated prompt request; an output processing module coupled in communication with the fine-tuned large language AI model to receive the output response, parsing the output response, reflects the input prompts, adds or updates missing context, and generates an overall usable output response; and a vector services module coupled in communication with the large language tasks module and the vector service database, the vector services module receives service data, recognizes text in the service data and embeds the text with the service data, and writes the service data as selected service data into the vector service database, the vector services module further retrieves a semantically similar vector and associated index into the service data based on the updated prompt request.

### BRIEF DESCRIPTIONS OF THE DRAWINGS

FIG. 1A is a block diagram map of software modules and interface showing examples of features to support a service provider virtual communication system using a large language machine learning model for an enterprise company.

FIG. 1B is a block diagram of a large language model (LLM) machine learning system implementing a service provider virtual communication system for equipment of enterprise businesses.

FIG. 2 is a block diagram of example of domain specific training or fine tuning of a general large language model using department of transportation's NHTSA data to support automotive service provider virtual communication system

FIG. 3 is a block diagram of features in the service provider virtual communication system including a batch AI pipeline, an LLM task execution and a user/program interface.

FIG. 4 is a block diagram of the service provider virtual communication system architecture including a batch AI pipeline, task execution software, and a user/program interface.

FIG. 5 is a block diagram of hardware systems that can execute portions of the service provider virtual communication system.

FIG. 6 is a block diagram of a vector database for the service provider virtual communication system.

FIG. 7 is a data flow diagram depicting a request and response sequence between a user/program interface and various other software module in the service provider virtual communication system.

FIG. 8 depicts various hardware involved in the virtual communication assist and the interaction between the hardware processing a user's question.

FIG. 9 is a block diagram of a user interfacing with the service provider virtual communication system.

FIG. 10 is a block diagram of a user interfacing with the service provider virtual communication system.

FIG. 11 is a block diagram of a sample use case of the service provider virtual communication system.

FIG. 12 is a block diagram of domain specific data labeling interacting with the LLM service software to support in context learning or fine-tuning.

FIG. 13A is a diagram of a chat user interface with a virtual agent for the service provider virtual communication system.

FIG. 13B is a diagram of a speech user interface with for the service provider virtual communication system with a question and answer interaction.

FIG. 14 illustrates a block diagram of a client-server computer system with multiple client computers communicating with one or more computer servers in a server center (or the cloud) over a computer network, such as a wide area network of the internet.

FIG. 15 illustrates a block diagram of a computer system for use as a server computer and client computers (devices) in the system shown in FIG. 14.

### DETAILED DESCRIPTION

In the following detailed description of the disclosed embodiments, numerous specific details are set forth in order to provide a thorough understanding. However, it will be obvious to one skilled in the art that the disclosed embodiments may be practiced without these specific details. In other instances, well known methods, procedures, components, and subsystems have not been described in detail so as not to unnecessarily obscure aspects of the disclosed embodiments.

The embodiments of the invention includes a method, apparatus and system for large language machine learning models for virtual communication by users, clients or customers with service providers. In one embodiment, the machine learning model is an automotive-specific AI co-pilot designed to augment and support automotive repair and service workflows. The machine learning model has access to data sets (data bases) such as NHTSA's public complaint and recall data base, technical service bulletins data base, and YouTube internet videos. It can also tap into vehicle service manuals and leverage a parts catalog with an application programming interface (API) integration.

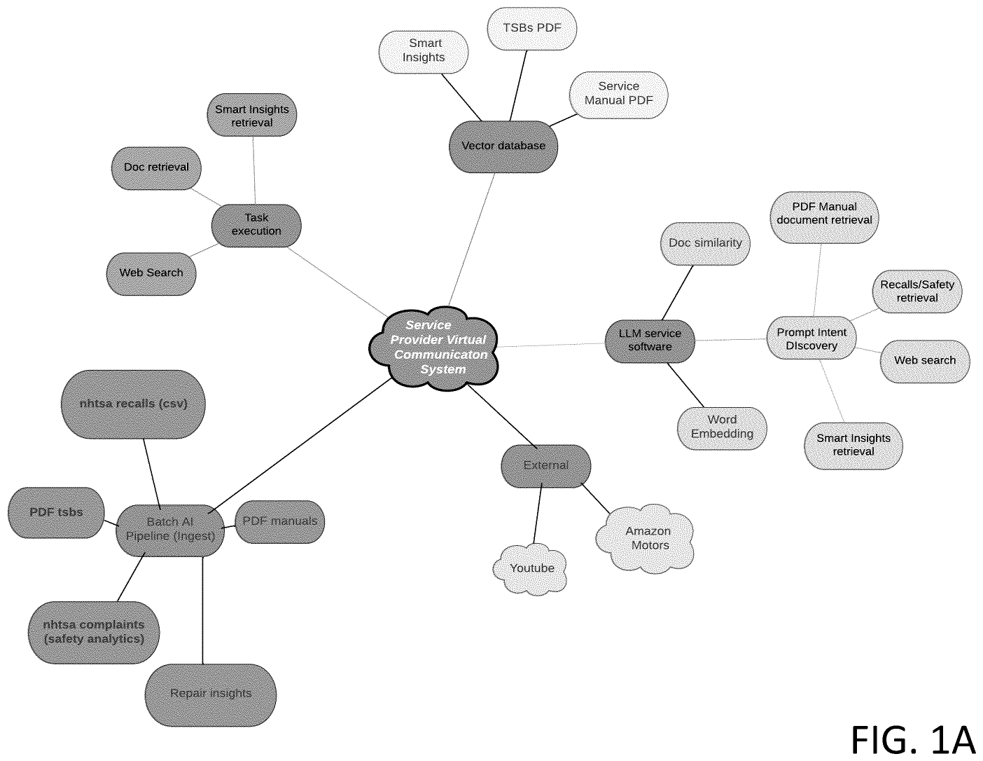

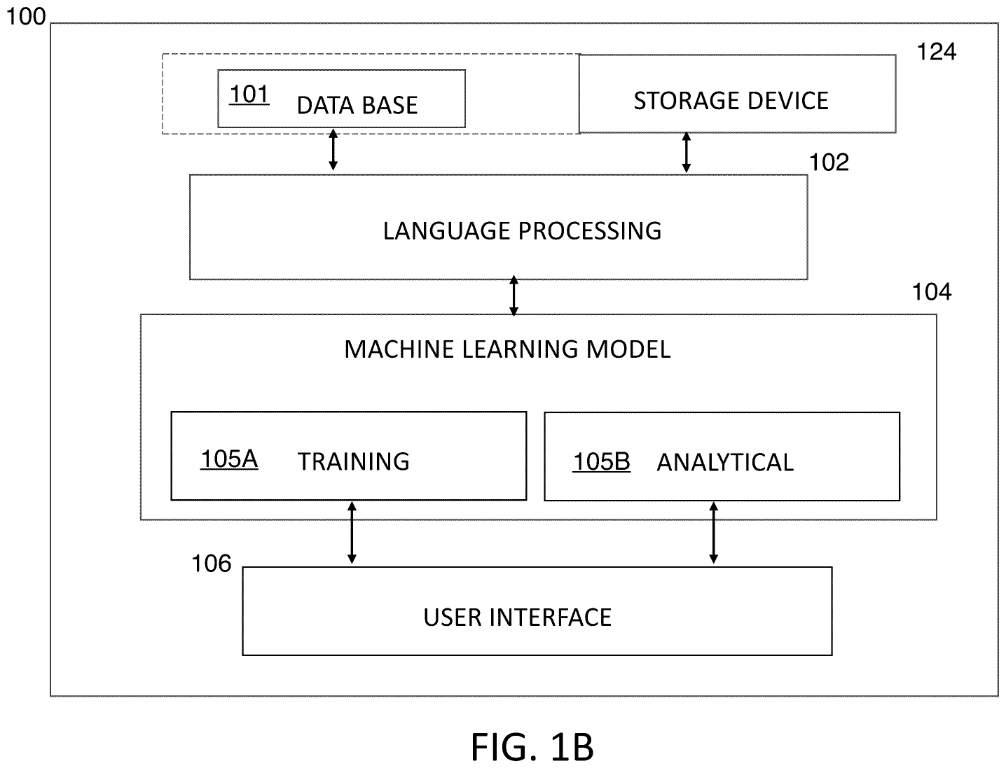

Referring now to FIG. 1A, a block diagram map of software modules and interface showing examples of features to support a service provider virtual communication system for an enterprise company is shown. The service provider virtual communication system utilizes using a large language machine learning model of artificial intelligence (AI). As shown in FIG. 1A, the service provider virtual communication system includes a batch AI pipeline to ingest various information associated with servicing products that are related to the enterprise company. The service provider virtual communication system includes a vector database that is generated from the ingestion process that can be used to form responses to queries into the system. The service provider virtual communication system further includes a task execution process that performs web searches, document retrieval, and smart insight retrieval to provide a response to queries into the system. The service provider virtual communication system further includes an interface to external user and sources, such as YOUTUBE for video information and AMAZON motors for parts information (e.g., pricing). At the heart of the heart of the service provider virtual communication system is a large language model service software component.

The large language machine learning (ML) model, a large language model, fine tunes generative artificial intelligence (AI) models for equipment of domain specific service provider applications. In automotive-specific equipment domain AI applications, the automotive-specific context in a user's question to the large language model can lexically or semantically have similar meaning to another term, however, in automotive specific context, it might have a completely different meaning. For example: oxygen sensor and air flow sensor might semantically have very similar score based on cosine similarity or embedding models like e5Large, however oxygen sensor is used to measure the amount of oxygen (unburnt) in the exhaust system vs air flow sensor or mass air flow sensor measure the air density as it enters into the engine. Some of the models get confused between oxygen sensor and air bag sensor. Automotive domain has its own jargon of terms for parts, systems, subsystems, acronyms, labor operations, aliases, slang terms that are unique to a region (like shimmying means abnormal vibration (of steering wheel)) To understand the intent of the user query or conversation or request, the model should be well versed in the service provider's domain. A service provider for automotive or fleet maintenance, or flight maintenance or train maintenance or any engineering product like dishwasher, refrigerator, turbine, has specific trade school learnt vocabulary and manufacturer specific vocabulary, or region specific vocabulary based on local culture. The large language model understands the context either as part of training and/or fine-tuning process of the model or during in-context by retrieving related terms from provided corpus of knowledge about the product.

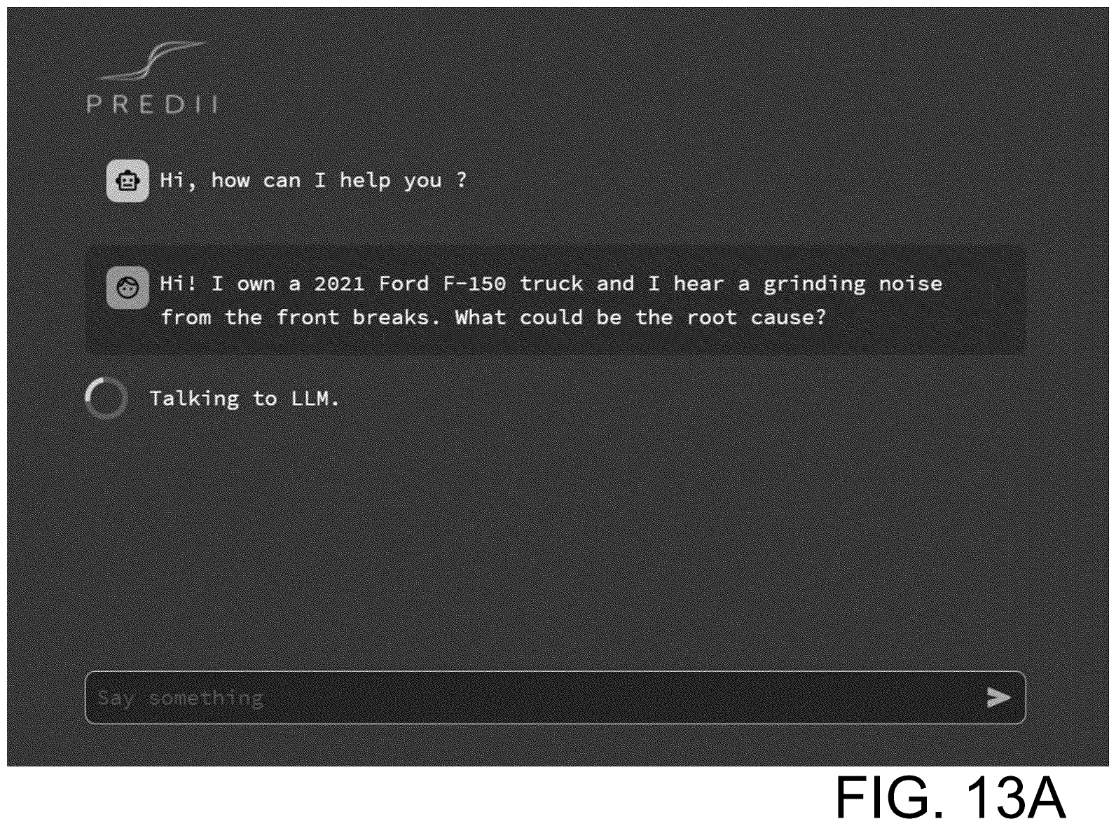

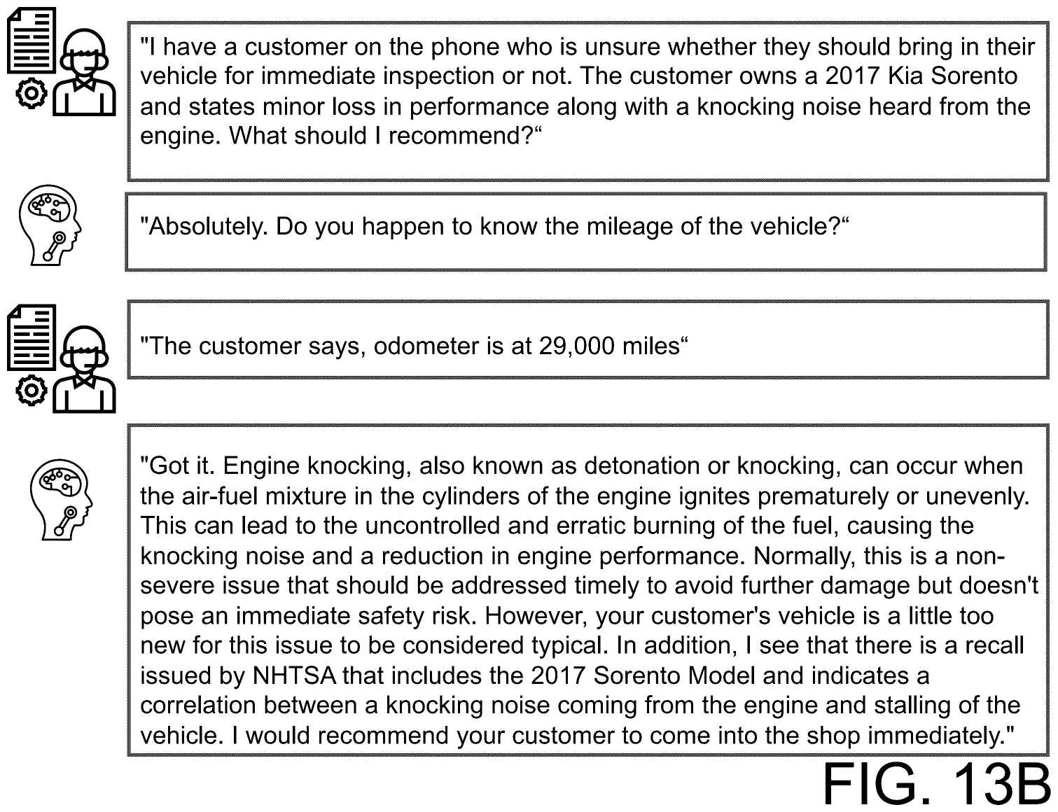

Input prompts to the system are provided by a user via an interface. The interface can also be accessible to the user to receive the initial output response. The interface can be an output device accessible to the user. In some cases, the output device is a display device and the response from the system is displayed to the user on the display device. In other cases, the interface can be a speech user interface. FIG. 13A is a diagram of a chat user interface with a virtual agent for the service provider virtual communication system. FIG. 13B is a diagram of a speech user interface with for the service provider virtual communication system with a question and ask interaction. The ML model understands the intent of questions in the context of automotive repair procedures and can intelligently gather and summarize information from both public and custom data sources. The ML model simulates the experience of talking to an expert technician, service advisor, or parts specialist-all in one place, in a chat interface or a voice-controlled interface via a user interface (UI) software module. The UI also provides an API for interfacing to other applications that a user or client may desire. The UI supports natural language processing (NLP) through the large language model.

Referring now to FIG. 1B, a high-level block diagram of an LLM support system 100 is shown that utilizes machine learning. The large language model (LLM) machine learning system 100 that can implement the service provider virtual communication system for support of equipment of the enterprise businesses. The system 100 includes a language processing subsystem 102, a machine learning (AI) model 104 that can be trained, and a user interface 106. The machine learning (AI) model 104 can be trained for use with one or more machine learning algorithms (including LLM algorithms) and then used with the one or more machine learning algorithms for providing support services of equipment by enterprise class companies to client/users.

The language processing subsystem 102 can read text stored in a storage device 124 and other text and data from one or more databases 101. The text and other data stored in the one or more databases 101 can be read via the internet into the storage device 124 and the database 101 for cloud processing. In one embodiment the database 101 is stored in the storage device 124 while in another embodiment, the one or more databases 101 are stored in another storage device (e.g., memory, solid state drive (SSD), disk drive) separate from the storage device 124. In other cases, the one or more databases 101 and the storage device 124 can be local and locally processed by a server having sufficient hardware and volume.

The language processing subsystem 102 can generate vectors from the input data in databases 101 that can be used to train the LLM machine learning (AI) model 104 to provide the support services.

The machine learning (AI) model 104 can be trained to provide useful and accurate information about support services for equipment. In one embodiment, the machine learning (AI) model 104 is used with one or more classifier algorithms to identify the intent.

Once input data is processed by the language processing subsystem 102, the textual data can be used to train the AI model 104 in a training mode 105A. The AI model 104 can be validated with additional data that is excluded from the training process. If the AI model 104 has been previously trained (pretrained), it can be refined and then used in an analytical mode 105B to generate responses to input prompts. In the analytical mode 105B, an input prompt is acted upon to generate an output response through the communication interface 106.

A program or user can interact with the system 100 through the application/user communication interface 106. The communication interface 106 can be used to refine the LLM AI model for a new type of business. The communication interface 106 can also be used to receive an input prompt and deliver a generated response from an output processing module to the user/program.

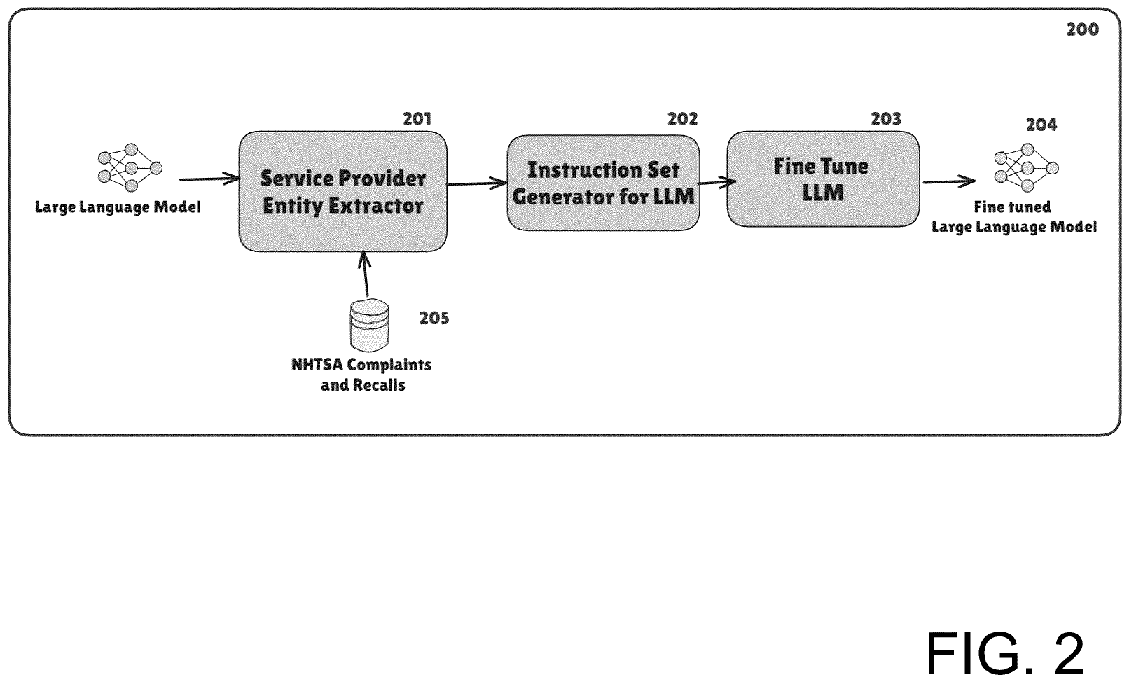

Referring now to FIG. 2, a large language model is initially trained in the context or intent of the enterprise business. The large language model can then be fine-tuned 203 by adjusting parameters to the specifics of the service. In FIG. 2, the LLM is fine-tuned with labeled data extracted from automotive data, such as NHTSA complaints and recall data 205 stored in a database, by a service provider entity extractor 201. A domain specific instruction set 202 is generated for the LLM to provide the fine tuning and adjust the appropriate parameters. An artificial intelligence (AI) pipeline is used to pre label information in databases that can be used for language model training. Word labels are generated in a unique way that can be used for training or fine tuning basic LLM model algorithms. There is pre-training of AI models and there is subsequently training or fine tuning of AI models. Pretraining of an AI model is from scratch. Fine tuning uses a pretrained generic AI model and trains it further in different ways. A generic LLM model is fine tuned to understand industry specific terms like components, repairs, failures that are specific to a service operation. That is, the parameters of a generic large language model are adjusted to pay attention to industry specific terms that are used in the servicing of equipment. In the automotive industry, the equipment could be a vehicle, such as a car.

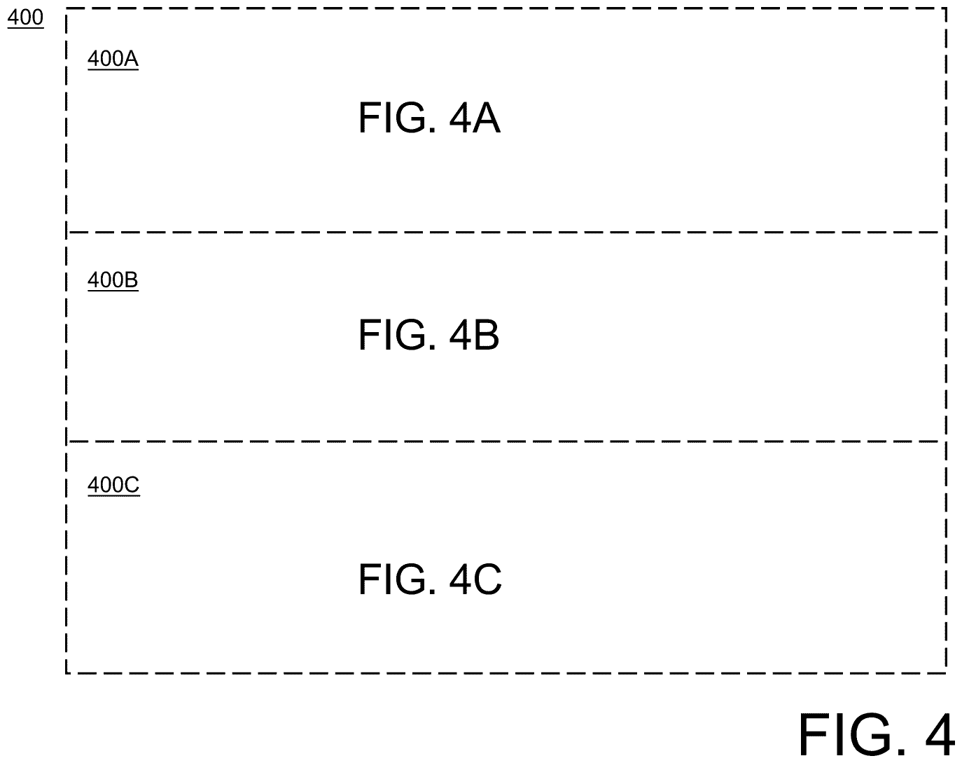

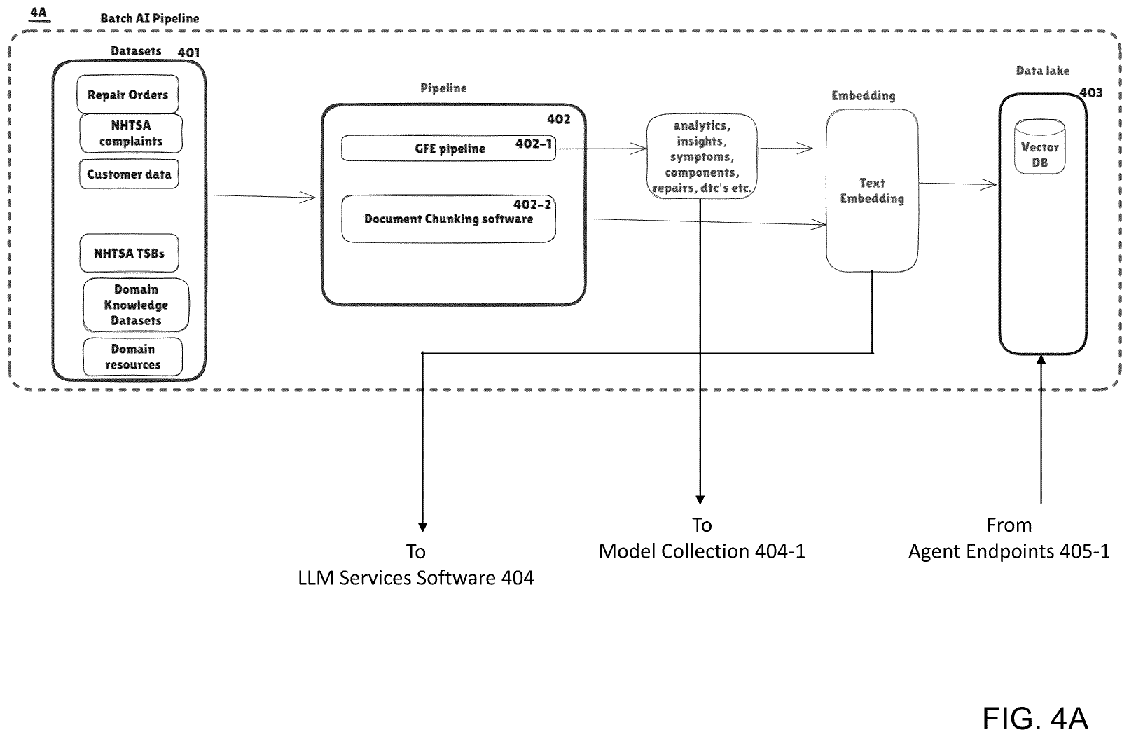

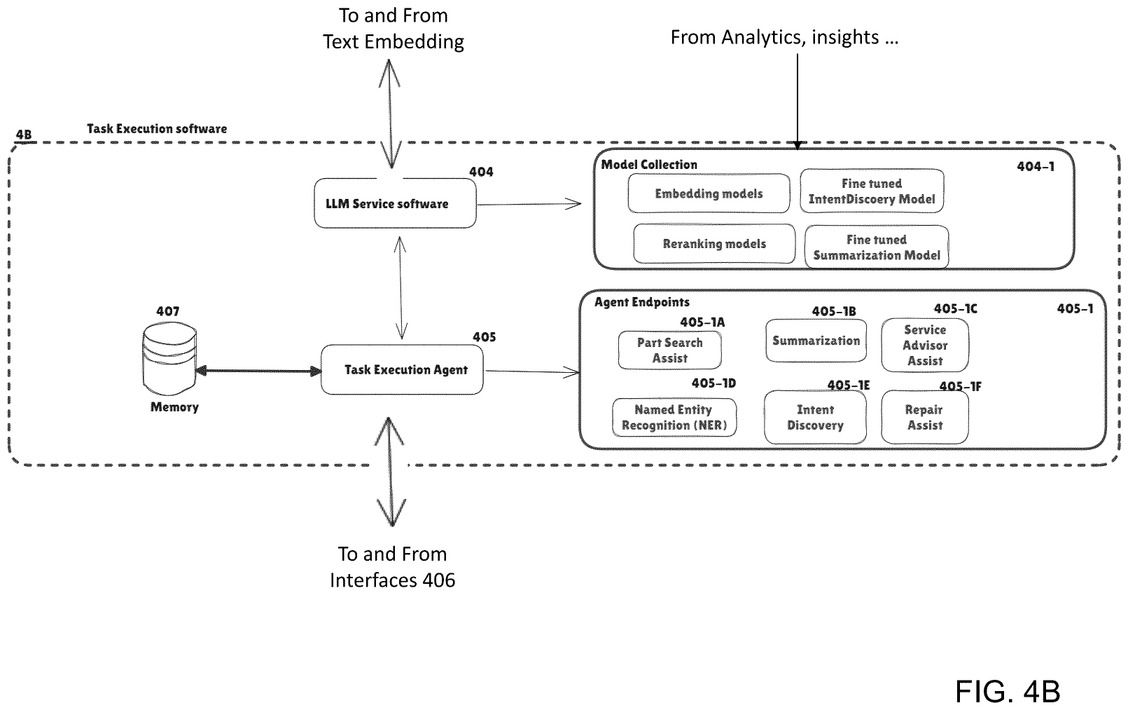

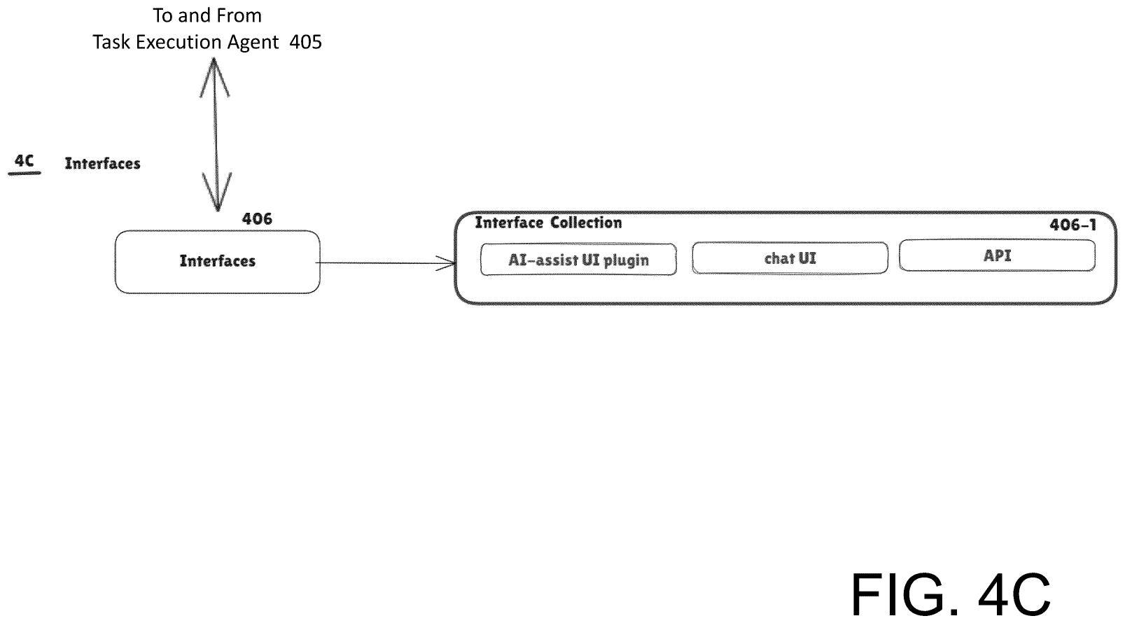

The named entity labels are very specific to the domain or industry and may also be referred to as domain specific labels. One domain or industry for example is automobile or vehicle servicing. Other domains or industries can be Aeronautics, special equipment, healthcare equipment, computer equipment, appliances, telecommunication equipment, trains, or engineered equipment that requires servicing by a human. These domain specific labels produced by a generic feature extraction (GFE) pipeline 402-1 and a document chunking software pipeline 402-2 shown in FIG. 4A will be stored in vector data base in a data lake 403 accessible by LLM service software 404.

An input interface can be an application programming interface (API) or a user interface, such as a graphical user interface or a voice (speech language) user interface. An example graphical interface is a virtual chat window with a virtual chat bot to provide a text-based interaction. For example, the text can be input prompts from a user/client with the virtual chat bot. The input prompts can be language processed and submitted to the LLM that generates responses to those input prompts. In other cases, speech may be the input prompt and converted to text.

Domain specific intent discovery 405-1E is used to discover the intent of the input prompt. For example, is the prompt related to the auto industry or some other industry. During fine tuning, the parameters of the large language model are adjusted so that it can discover the domain specific intent.

The training or fine tuning further of the LLM goes into industry specific question and answer tasks. These basically are specific tasks related to questions and answer tasks. There's another task called a named entity recognition (NER) task. All are considered LLM tasks performed inside the Task execution agent 405 using specific endpoints. NER 405-1D agent endpoint perform domain specific named entity recognition like retrieving component, repairs, failures, equipment parameters (model, year, manufacturer name, engine size, identification number) from the user query. The parameters are adjusted for industry specific tasks based on question-and-answer classification.

There can also be a machine language translation task when different languages are used by an equipment provider, and another is used by a service provider. For example, parts and service information may be in the German language for a German manufactured vehicle but the service provider reads and understands the English language. The LLM can also trained to recognize foreign languages for parts, service information-a multi-language industry specific vocabulary of words that are used. For example, an oxygen sensor in the German language is sauerstoff sensor. The LLM can be further fine-tuned with added training to recognize the foreign language words that are specific to the desired service industry.

A sample input question on one end of the spectrum could be from an owner of a vehicle. “I drive a 2018 Ford F-150 with forty-eight thousand miles and I'm starting to hear a knocking noise from the engine. What is that from? How bad is this? Another sample input question on the other end of the spectrum could be from a technician trying to repair the equipment. The technician can ask the input question: “I have a P03O1 no start issue on my customer's truck. What could it be? Another input question could be “How do I replace the spark plug?” This is the type of spectrum of questions that a virtual LLM system could expect. Not all questions can be only service related. Other questions may be related to the brands and ask questions about a product being sold.

The LLM can act like the service advisor that greets a customer seeking service of his/her equipment. You walk in into the service lane. The first interaction with the customer is to get information regarding customer's issue/request. Once you have the service issue, then the service advisor can take that and communicate that back to the technician. The technician can communicate back with parts and labor information required to make the repair. Service advisor uses this information to produce a most probable repair estimate to the customer. This workflow is a service workflow.

There is an associated context from industry specific databases and customer specific databases. For example, we have information around a customer database of issues and resolutions to those issues from a bill for service associated with a customer. Each next time this service issue comes up; the prior issue and resolution is available in the database for use as a future resolution.

A customer database is received from a service provider. Not only is the large language model being used, but the customer database can also be used with the language model to retrieve the appropriate results in a hybrid manner from the customer as well as from our language model. A customer specific response can be a hybrid response from both the LLM and the customer data base.

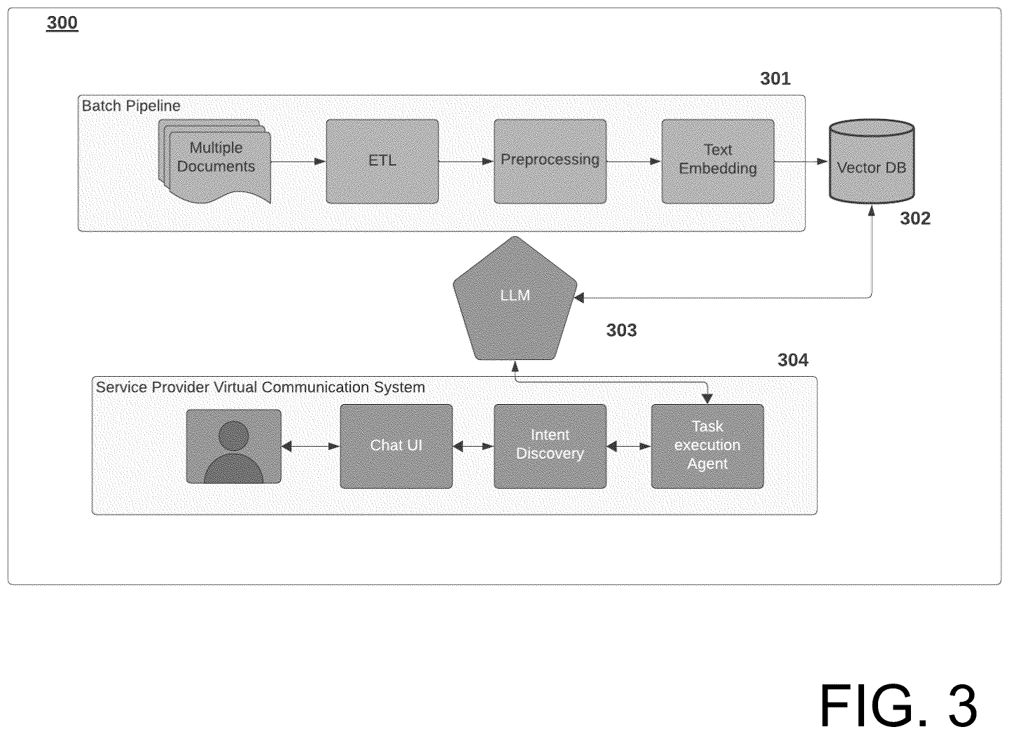

Referring now to FIG. 3, the service provider virtual communication system generally includes a batch AI pipeline 301, an LLM task execution 303, and a user/program interface 304. A user can directly interface to the system by a user interface such as a chat user interface. Other programs can interface to the system via an application programming interface (API). The batch pipeline is to ingest information about the business and the equipment or products being serviced and store them in a vector database 302. The system revolves around the vector database 302 of information that is generated during the machine learning process, and which is periodically updated in a continuous manner by the batch ingestion process.

Referring now to FIG. 4, an architecture of the machine learning system 400 for the LLM service providing software is shown. The system architecture is a scalable, modular framework for processing and analyzing datasets in various domain or industry specific scenarios. It integrates batch processing, LLM services, domain-specific task agents, and user interfaces to provide a versatile platform that supports diverse applications and seamless expansion. The machine learning system is composed of multiple integrated components that function collaboratively to process, analyze, and extract insights from various datasets. The machine learning system is designed to be scalable, modular, and capable of supporting multiple services leveraging fine-tuned LLM models for specific tasks. The machine learning system 400 can be broken down into three main sections, a batch AI pipeline (ingestion module) 400A, task execution software (module) 400B, and user interfaces (input module) 400C.

The Task execution software 400B is the second layer in the system architecture and is tasked with providing core services to interact with large language models, agents, and interfaces. The LLM service software 404 provides machine learning and LLM-based intent and summarization capabilities. It consists of a collection of customized large language models 404-1 including a fine tuned intent discovery model and a fine tuned summarization model, embedding models, and reranking models. These customized large language models (LLM) are trained on domain-specific datasets, enabling them to understand and process domain-specific language, terminology, and contexts. The training or fine tuning uses domain specific data generated by the batch AI pipeline 400A to improve accuracy and relevancy of the results produced by the LLM models. The embedding models are responsible for converting textual data into embeddings. They serve as the backbone for information retrieval and semantic understanding across the platform. Reranking models refine and rank results based on relevance. This ensures that the most relevant insights, suggestions, or search results are prioritized for the end-user.

Task execution agent 405 is an agent services layer that provides domain-specific functionalities to support various applications. Agent services tap into the collection of agents based on the intent discovery. All agent services consult with memory 407 to keep track of conversations and interactions between interfaces 406 and agent services. Memory is also used during retrieval of information from the data lake 403 of one or more databases, including a vector database, to return back domain specific information that was previously retrieved. The conversational history stored in the memory allows the interface to respond back with most probable follow-up questions based on domain knowledge either stored in the memory or available in the data lake. These services leverage the embeddings and LLM capabilities of the LLM service software 404 to offer targeted solutions. An agent end point collection 405-1 consists of intent discovery, summarization, NER, part search assist, service advisor assist and repair assist. Domain specific intent discovery 405-1E uses LLMs to analyze textual data and accurately identify the intent behind user queries or textual inputs. It enables efficient routing and response generation in domain specific contexts. The NER module 405-10 identifies specific entities such as parts, components, and vehicle models from the text, facilitating structured analysis and data extraction. Part search assist service 405-1A is designed to assist users in finding automotive parts based on text queries. It leverages embeddings to match query terms with domain-specific parts. Repair search assist 405-1F predicts potential issues, corrective actions, and trends based on historical data, offering insights into vehicle performance and maintenance. It also integrates statistical analysis with LLMs for enhanced prediction accuracy. The agent end point collection 405-1 has the ability for additional services that can be integrated in the future, demonstrating the scalable nature of the architecture.

The machine learning system 400 can alternately be described as having three different subsystem modules in the system, an ingestion module (FIG. 4A), an input module (FIG. 4C), and a task execution module (FIG. 4B). The input subsystem module 400C is in communication with the task execution module 400B. The ingestion subsystem module 400A is in communication with the task execution module 400B. The task execution module 400B is in communication with both the ingestion subsystem module 400A and the input subsystem module 400C. A Batch AI Pipeline 400A is responsible for data ingestion, extraction, transformation, and embedding. The task execution software 400B hosts and manages LLM models 404-1 and a task execution agent 405. These agents provide domain-specific functionality such as domain specific intent discovery 405-1E, named entity recognition (NER) 405-1D, part search assist 405-1A, service advisor assist 405-1C, repair search assist 405-1F and summarization agent 405-1B. The input module 400C comprises various user interfaces including user/program interfaces 406-1 that provide user interaction and integration through an AI assist user interface plugin, chat UIs, and APIs. These user interfaces can also be used by the output module to output responses.

The input subsystem module 400C shown in FIG. 4C is a communication interface to allow API and UI to interface with programs and users. The communication interface can include a virtual agent to interface with a user to form text that form a request of the system and delivers responses back. User interfaces 406 communicate with the task execution agent 405. The user/program interfaces 406-1 provide methods for users and external systems to interact with the platform by means of an AI-assist user interface plugin, a chat user interface, and/or one or more application programming interfaces. The AI-assist user interface plugin is designed to integrate with existing systems, providing AI-powered assistance directly to users. The chat UI is an interactive chat interface that allows users to ask questions, seek assistance, and interact with the underlying services seamlessly. The one or more APIs includes the RESTful APIs adhering to OpenAPI standards that enable easy integration with external applications. These APIs expose the functionalities provided by the agent services, allowing for automation, system integration, and programmatic access.

The task execution module 400B shown in FIG. 4B is task execution software. The LLM services listen for requests to perform tasks and serve the requests. The fine-tuned Large Language Model provides for a use-case specific knowledge ingestion and retrieval framework. The LLM service portion provides an Intelligent Intent Response Network (IIRN) 902, which understands industry specific intents of questions and responds by pulling in custom knowledge sources. The LLM service portion interprets the prompt inputs that are received by the user/program interface such as from a virtual chat.

The LLM service layer includes a vector services module, an LLM tasks module, the fine-tuned LLM model, and an output processing module. The LLM tasks module is coupled in communication with the communication module to received tasks based on the input prompt. The LLM tasks module is coupled in communication with the fine-tuned LLM model in order to communicate the input prompt and receive a generated response. The LLM tasks module is further coupled in communication with the vector services module in order to process new input text. The large language tasks module receives one or more input prompts from an interface. The large language tasks module has industry specific tasks to perform including questions and answer tasks, named entity recognition, classification tasks, and machine translations tasks. The large language tasks module receives the one or more input prompts, performs intent discovery, generates an updated prompt request based on one or more input prompts.

A fine-tuned large language AI model is coupled in communication with the large language tasks module. The fine-tuned large language AI model receives a new or updated prompt request and processes the updated prompt request generating an output response based on the new or updated prompt request.

The output processing module is coupled in communication with the LLM tasks module in order to output the generated response. The output processing module is also coupled in communication with the interface. The output processing module parses the output response, reflects or includes the one or more input prompts, adds or updates any missing context, and then generates an overall usable output response that can be provided to the user through the interface.

A vector services module is coupled in communication with the large language tasks module and the vector service database. The vector services module receives service data, recognizes text in the service data and embeds the text with the service data, and writes the service data as selected service data into the vector service database. The vector services module can further retrieve a semantically similar vector and associated index into the vector service data base based on an updated prompt request.

When a prompt comes in from a user/program, it is communicated to the LLM tasks module for interpreting the intent. Based on the prompt, it is redirected to whichever task it is to be performed. A query is formed and communicated to the vector services to retrieve a vector and its associated data. The query is generally passed onto the vector database. There is interaction between the UI input, LLM, tasks and the vector services. The vector services is used read information from the vector database by submitting a question and getting an answer back.

Intent is a first task that is performed. Part of the task is an intended discovery classification task. Once you learn of the intent and an intended discovery task, the system can execute the task. The tasks are industry specific tasks. The vector services module and the task module are coupled in communication together to communicate back and forth.

An input prompt is modified by a prompt intent discovery into an updated query. The updated query is communicated to the fine-tuned large language model for it to generate an output. The generated output is communicated to the output processing model to format it into a human readable output response. The prompt intent discovery discovers what a user is actually asking about. It creates a new query that is submitted to the model. The generated model output is then parsed into a usable format and returned back. Before return, additional information may be added to the parsed data.

A response output might not have what you requested properly. A response output will summarize what you asked to be sure it was captured accurately. For example, it can say you requested information about Ford F-150 2002. The system remembers what you have requested earlier because it remembers the conversation you're having. A request may be a compound request and not just one. For example, assume a user asks one question such as I own a 2018 Ford F-150, and I have only this issue that is the first prompt. Then a following request could be—Are there any recalls you know about with regards to this issue. Now question one and question two are joined together as part of a conversation with the user. They are not independent questions. If the user asks one more question, the first prompt, the second prompt, and the third prompt are considered as a collection that is then responded to. The sequence of questions are stored in memory so the response for every individual question is within the context of what is being discussed—e.g., the 2018 Ford F-150. The context of the conversation is added into a usable response back to the customer. The system maintains the context of the conversation with a user/client. That context back is added into the response to the user/client. Context added into the response assures that a conversation is occurring with the user/client.

The Task execution software 400B interprets search requests based on the input prompt. It performs reading, writing, and word embedding tasks to generate a usable output response. Based upon the input prompt a search may discover related documents that need be read, such as a PDF document for the technician and repair procedures for a service issue of the equipment. The writer and word embedding tasks may generate data in the vector database to form a useable output response.

The ingestion subsystem module 400A shown in FIG. 4A, is a batch AI pipeline that is used to periodically refine the LLM model based on new information stored in the databases. The Batch AI Pipeline is the first layer in the software architecture and is tasked with processing large volumes of data from various sources. In the automotive service domain, the batch AI Pipeline can extract features from billions of automotive service data points. The batch AI pipeline is generally offline data processing where data can be processed, and vectors generated based on new information.

The generated vectors, the output from the batch AI Pipeline, are stored in the vector database 302 in the data lake 403. The batch pipeline is not directly coupled to the user interface to directly receive user input or prompts directly. The batch pipeline is run for a data set using the word embedding of the middle layer and storing that information into the vector database. For example, technician technical details, needs or repair orders processed to extract text and embed the text (word embedding) associated with the document and store that data into the vector database. The batch processing updates the vector database. The vector database is a dynamic database that is periodically updated in the background by the batch pipeline processing. An updated vector database is coupled to a fine-tuning system to determine if the LLM service model should be further fine-tuned.

Various datasets 401 are processed by the batch AI pipeline 402. In the auto-repair service domain, the various datasets 401 that are processed by the batch AI pipeline 402 can include Repair Orders, NHTSA TSBs, Complaints, Recalls and equipment service history. These are core datasets that contain information related to automotive repairs, technical service bulletins (TSBs), complaints, and recalls. Other Domain knowledge Datasets and domain Resources can be processed. These additional data sources provide auxiliary information or domain-specific resources to the system.

The batch AI Pipeline 402 includes a generic feature extraction (GFE) pipeline 402-1 and document chunking software 402-2 implemented together and are a scalable pipeline that can grow with needs or demands. The pipeline 402 facilitates data processing by extracting information from various datasets, transforming it into a structured format, and loading it into relevant storage or embedding pipelines. The GFE pipeline 402-1 components process data to extract feature sets required for further analysis. It includes the ability to generate insights, identify symptoms, components, and repairs, and detect diagnostic trouble codes (DTCs). The document chunking software 402-2 provides mechanisms to break down large documents into manageable chunks while maintaining contextual integrity, ensuring efficient data processing and understanding.

After batch processing with the batch AI pipeline 402, the data is passed through an embedding module that converts the textual information into dense vectors for machine learning models. That is, it performs a text embedding process into vectors. The use of vectors facilitates efficient searching, clustering, querying, retrieval and reranking of results in downstream applications.

The data lake 403 stores processed information, embeddings, and resources Vector DB repository. Vector DB stores vector embeddings generated from the processed data, enabling quick look up and similarity searches. A flexible external database system can also be used to store structured and unstructured data extracted from the datasets that doesn't require vectorization. Domain specific data includes domain-specific resources, taxonomies, ontologies, and models that augment the data processing and analysis tasks.

Generally, the system architecture 400 is a robust and scalable solution for processing, analyzing, and extracting insights from automotive-related datasets as well as other equipment data for other companies. By utilizing a combination of batch processing, embeddings, and advanced machine learning models, the system offers a comprehensive suite of services that can support a wide range of automotive applications. The modular design, integration capabilities, and scalability ensure that the platform can evolve and grow, accommodating new datasets 401, LLM models 404-1, and agent endpoints 405-1 as needs grow.

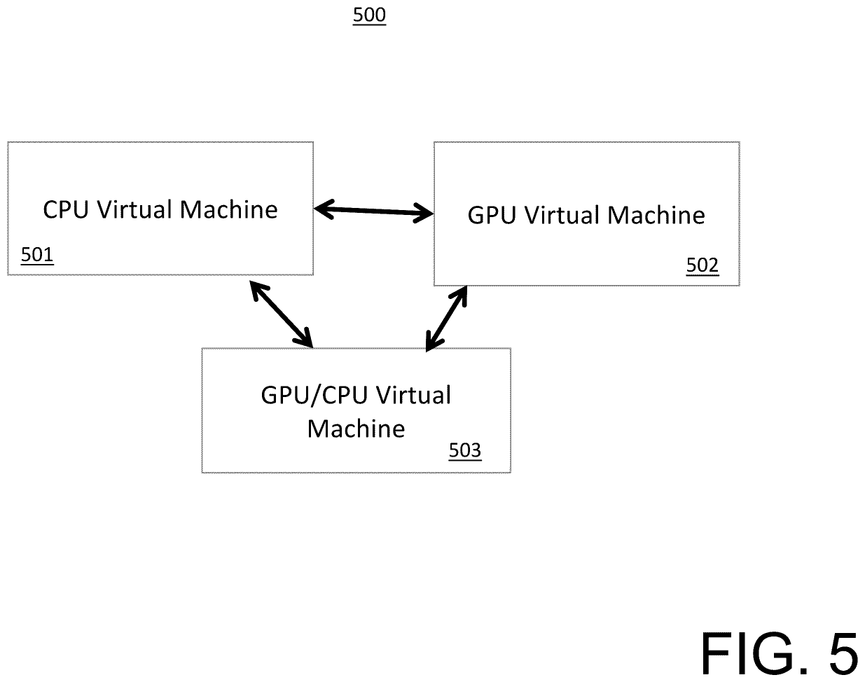

FIG. 5 is a block diagram of hardware systems 500 that can execute portions of the service provider virtual communication system. The hardware systems 500 can be virtual machines run on hardware in one or more datacenters. The hardware systems 500 can interact with one or more databases, including the vector database. The hardware systems 500 include one or more central processing unit (CPU) virtual machines 501, one or more graphical processing unit (GPU) virtual machines 502, and one or more combined GPU/CPU virtual machines 503.

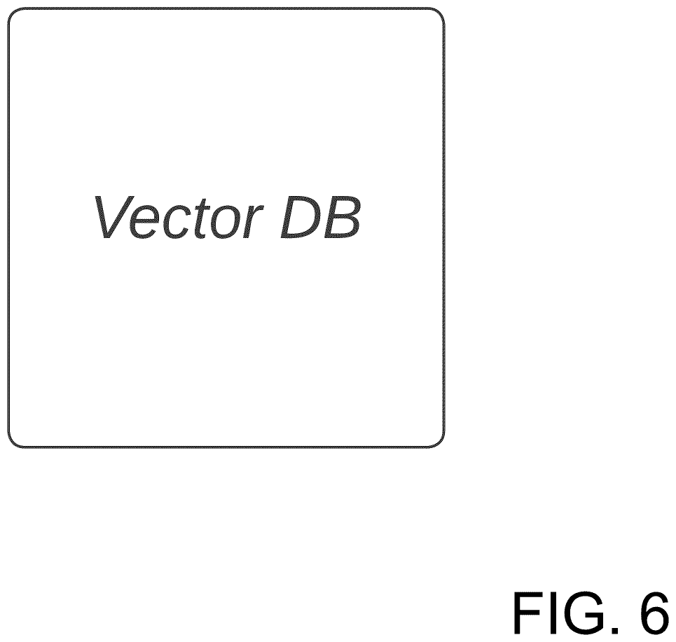

FIG. 6 is a block diagram of a vector database. The vector database can interface with the services backend modules to execute portions of the service provider virtual communication system. The vector database can further interface with the batch processing pipeline to store newly ingested information in vector format. The vector database stores word embedding vectors associated with selected service data of equipment associated with the service provider.

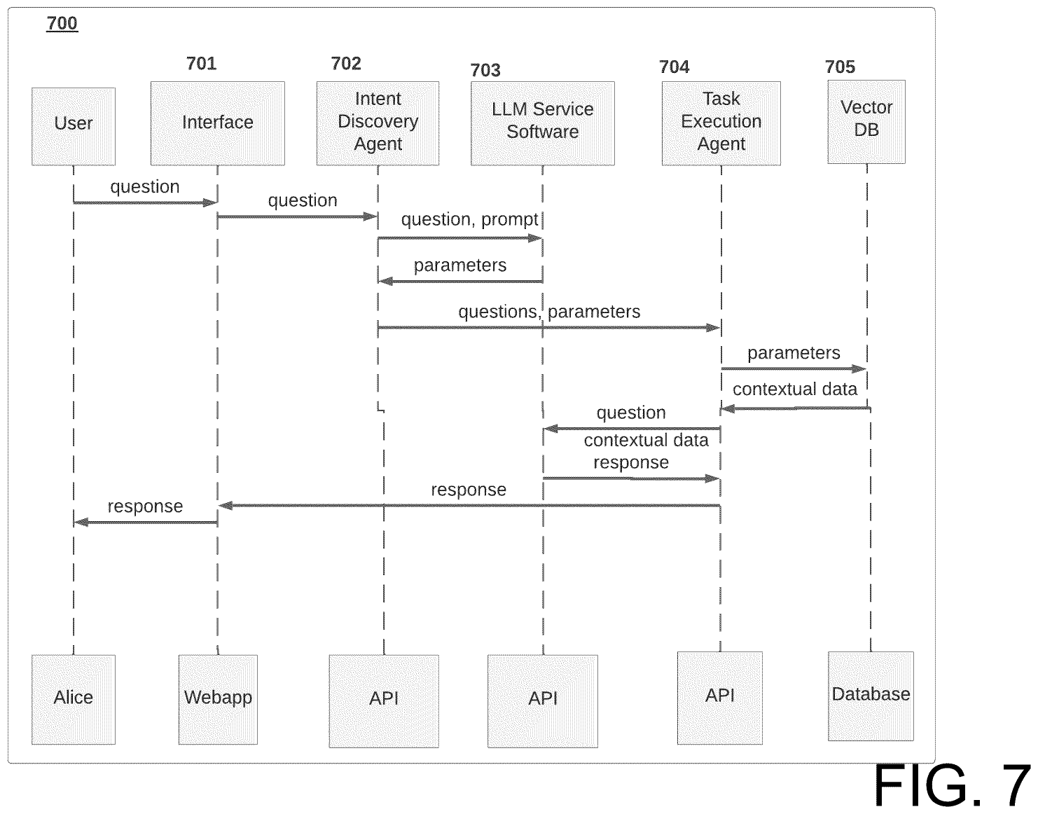

Referring now to FIG. 7, an interaction diagram shows data flow during an interaction between service advisor user and a virtual communication assistant or agent. Virtual communication assistant can be any of the interfaces from the interface 701 such as a Chat UI or an enterprise application or workflow application interacting via AI Assist UI plug-in to an existing enterprise application like service provider workflow software or Application Programming Interface (API). A user can interact with the agent by asking a question in a natural language (“show me top recommended repairs for a 2020 Ford F-150 at 30K miles”) or domain specific cryptic manner (“parts for 30K service”). A question from a user sent via the Interface 701 is then passed to Intent discovery 702, which performs domain specific intent discovery using LLM service software 703. Task execution agent 704 has agent specific prompt and combined with the user question creates an instruction to the LLM service software. Task execution agent 704 retrieves relevant context related to the question from the Vector DB 705. Agent 704 then sends an instruction to the LLM service software to get the final summarized response that is returned back to the user.

Acting like a Service Advisor, the UI software module using service advisor assist 405-1C reliably connects customer-reported symptoms with likely root causes and recommended repair procedures. The system is able to alert the user to severe safety concerns and recalls regarding a vehicle as reported to NHTSA.

Acting like a parts counter, with an API integration to parts catalogs, the UI software module interacts with Part Search Assist agent 405-1A and can suggest best fit options for required parts by year, make, model, engine (YMME) and price range.

Acting like a technician, the UI software module using repair search assist 405-1F summarizes vehicle-specific repair procedures step-by-step, recommends relevant technical service bulletins (TSB), and can even bring up related YOUTUBE videos associated with the recommended repair service.

As a market analyst, the UI software module using the summarization agent 405-1B can respond to analyst questions such as questions that are about market demand, shop performance, localized and vehicle-specific trends and parts forecasts.

The user/program interfaces 406-1 can be either a user interface, API, or an AI assist UI plugin. The interfaces 406 are enterprise-grade AI solutions that produce reliable, actionable results and can protect a customer's proprietary data. The system and its models work optimally around custom data that is hosted in an isolated environment.

The automotive industry is moving towards one-point-entry AI solutions that allow users to move beyond siloed information and interact with systems in a human like manner. Having an AI collaborator in the loop in expert knowledge dependent industries can improve the customer service experience.

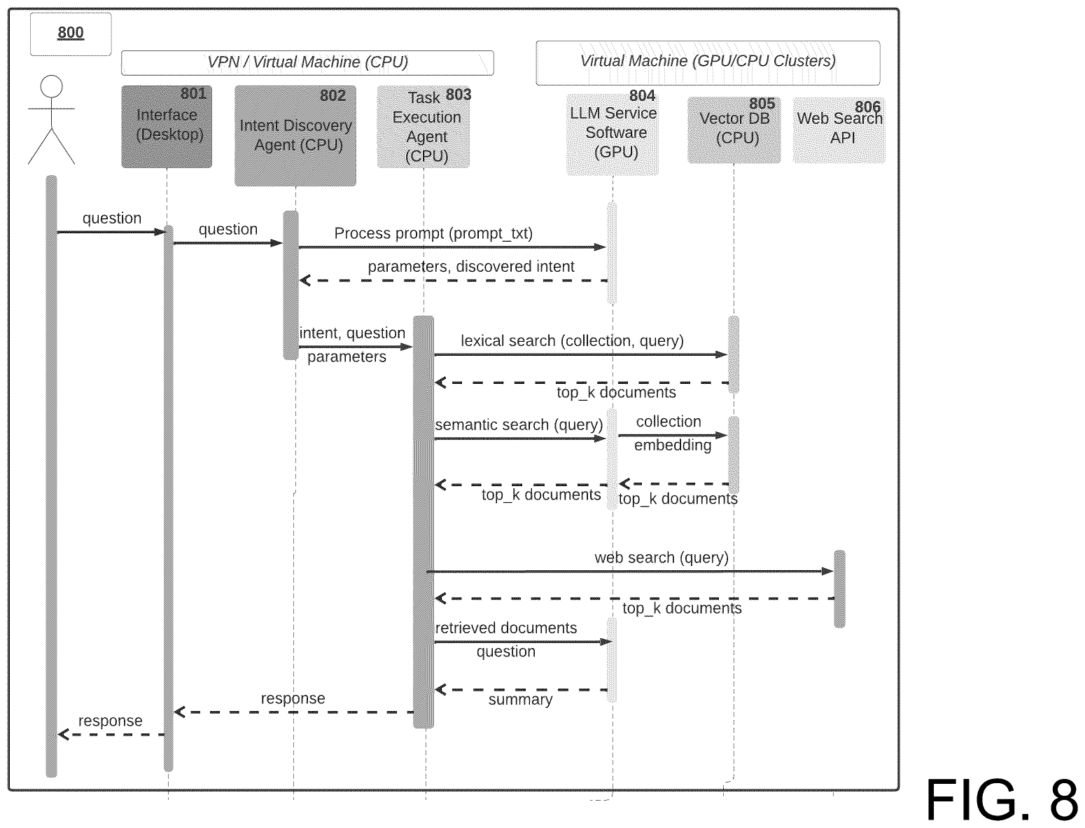

FIG. 8 depicts various hardware involved in the virtual communication assist and the interaction between these hardware while processing a user's question. A user can initiate the interaction by asking a natural language question on a desktop/computer. For this purpose, the user may choose to configure any of the interface options from the interface 801 on their computer. The user question is forwarded to the domain specific intent discovery agent 802 which is hosted on a virtual machine (cloud server). The intent discovery agent uses the LLM service software 804 to process the user's question. LLM service software module is deployed on another cloud server which has access to a cluster of Graphics Processing Units (GPUs). After receiving the processed response, intent discovery forwards it to the selected agent service based on inferred user's requirement. The task execution agent 803 runs on a virtual machine and interacts with LLM service software 804 and Vector database (DB) 805. Vector DB is hosted on a virtual machine. The agent service prepares the final response based on the interaction with LLM service software and Vector DB. The final response is then forwarded to the interface at user's computer for the user to consume.

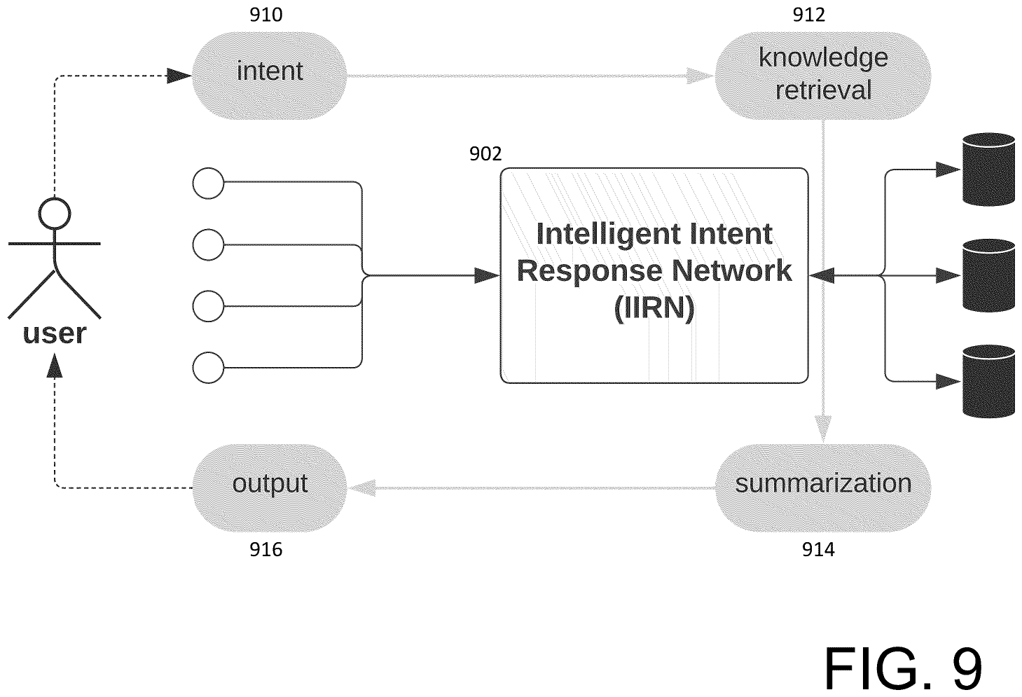

Referring now to FIG. 9, the AI software uses a hybrid model approach built on multiple software module components including an Intelligent Intent Response Network (IIRN) 902, automotive specific fine-tuned Large Language Model (LLM), use-case specific knowledge ingestion & retrieval framework. A specialized AI pipeline extracts features from billions of automotive service data. The IIRN 902 understands industry specific intents 910 in the questions and responds back 916, including a summary 914, by pulling data from a customer specific knowledge source 912. The AI Software acts as a light-weight Automotive AI collaborator/co-pilot working next to you day to day.

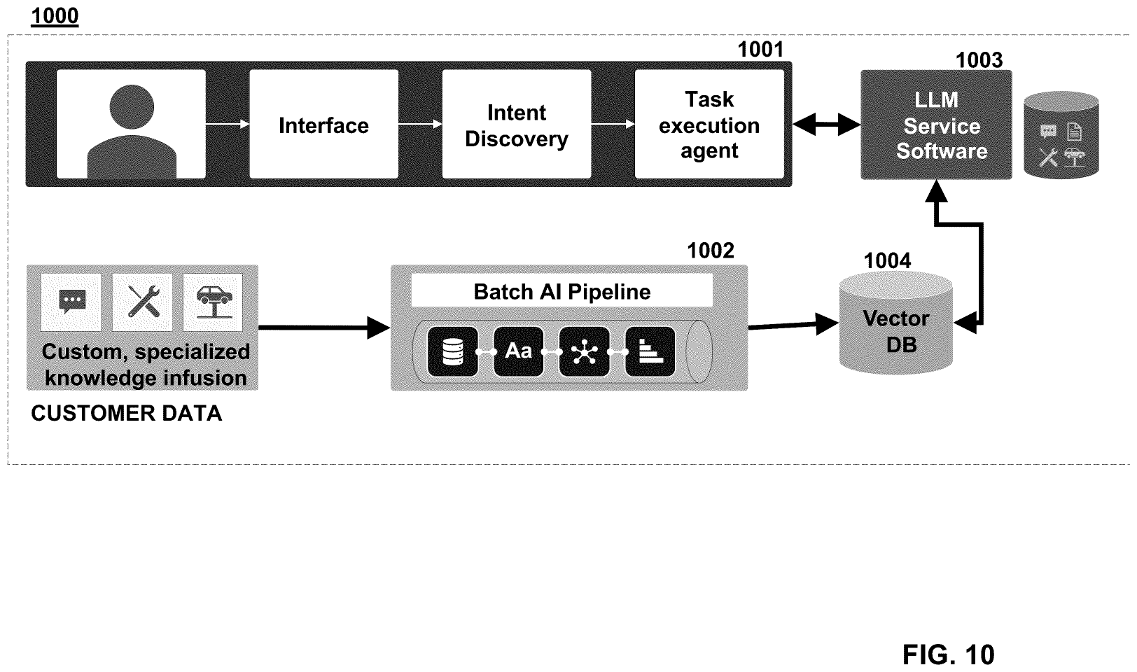

FIG. 10 is a block diagram of ingesting Customer data which is type of domain specific data used as domain knowledge ingested into the Vector DB 1004. Batch AI Pipeline 1002 is used to chunk the documents and perform generic feature extraction to ingest into Vector DB. 1001 is an inference pipeline using the knowledge infused into the Vector DB and LLM service software 1003 to respond to questions asked via Interface.

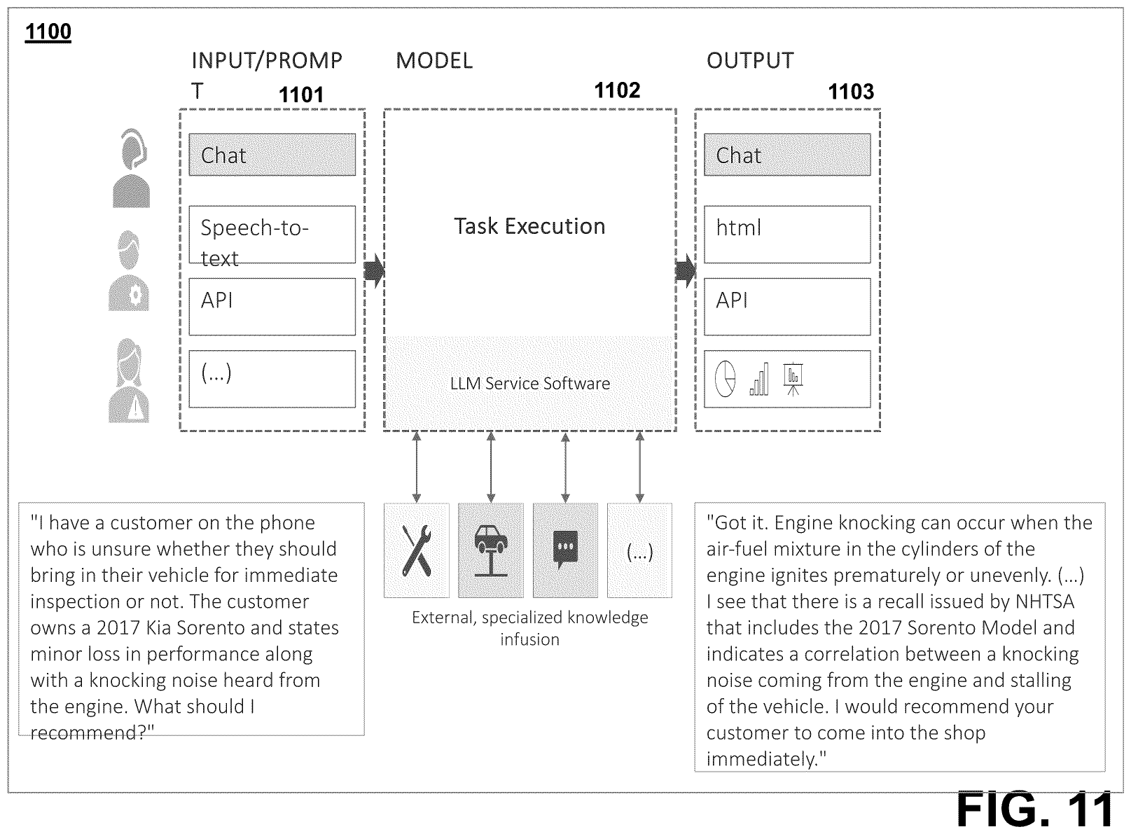

FIG. 11 is a block diagram of a sample use case showcasing multi modal inputs 1101 to the interface: text, speech to text, API. A sample question that a user ask via speech to text or chatbot or an enterprise software connected via API can be: “I have a customer on the phone who is unsure whether they should bring in their vehicle for immediate inspection or not. The customer owns a 2017 Kia Sorento and states minor loss in performance along with a knocking noise heard from the engine. What should I recommend?”. The Service provider virtual communication system will invoke task execution 1102 on the question and provide an output 1103 via chat, html or API. The example output 1103 can be “Got it. Engine knocking can occur when the air-fuel mixture in the cylinders of the engine ignites prematurely or unevenly. ( . . . ) I see that there is a recall issued by NHTSA that includes the 2017 Sorento Model and indicates a correlation between a knocking noise coming from the engine and stalling of the vehicle. I would recommend your customer to come into the shop immediately.”

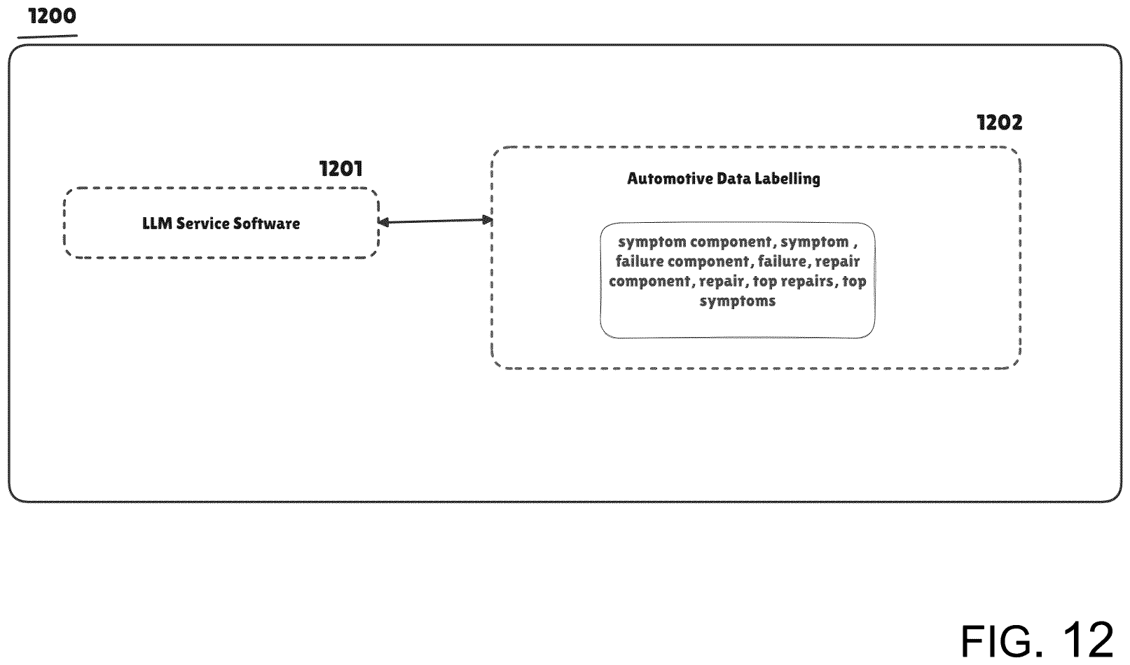

FIG. 12 is a block diagram of interaction between a LLM service software 1201 and an example of automotive data labeling module 1202 to use automotive domain specific data for fine tuning. Automotive domain specific labels or entities in the context of a service provider are symptom component, symptom, failure component, failure, repair component, repair, top repairs, top symptoms.

### Computer Network

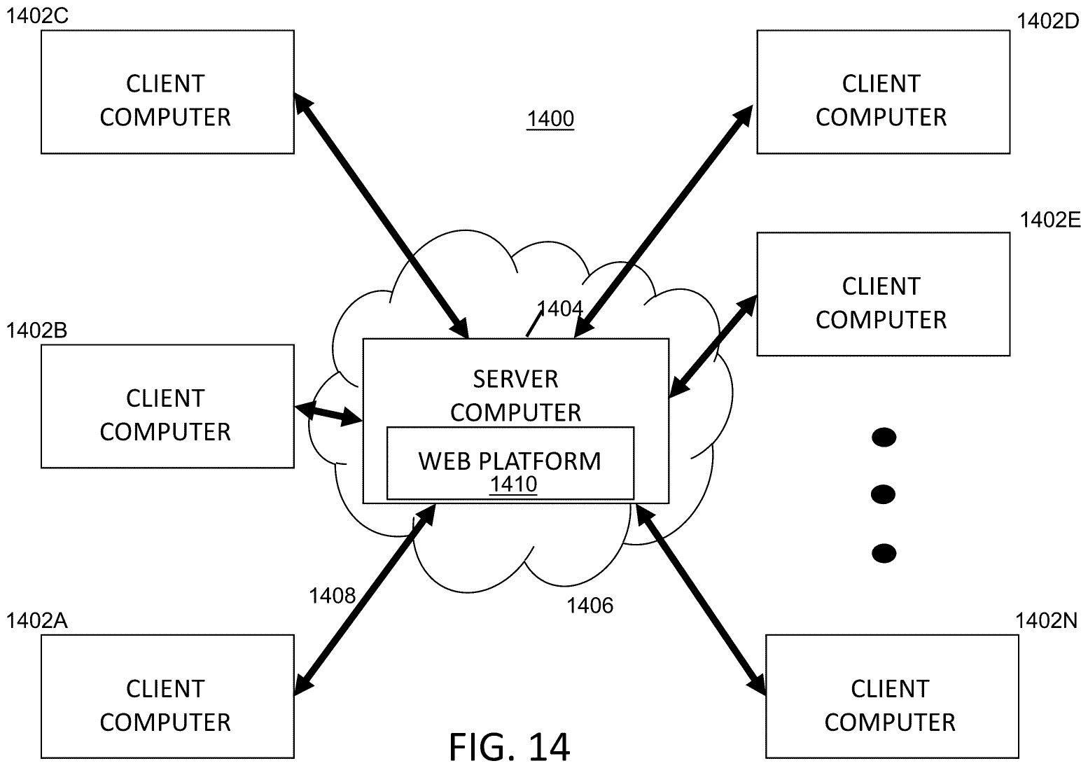

Referring now to FIG. 14, a block diagram of a client-server computer system 1400 is shown. The client-server computer system 1400 includes a plurality of client computers 1402A-1402N in communication with one or more computer servers 1404 in a server center (or the cloud) 1406 over a computer network 1408, such as a wide area network of the internet. The LLM support system can be executed on the one or more computer servers 1404 for access by the plurality of client computers 1402A-1402N to provide the support services of the equipment to clients/users. To provide neural network nodes, the computer servers 1404 can use a plurality of graphical processing units (GPUs) that can be flexibly interconnected to process input data and generate the desired support services output generated by the AI models.

### Computer System

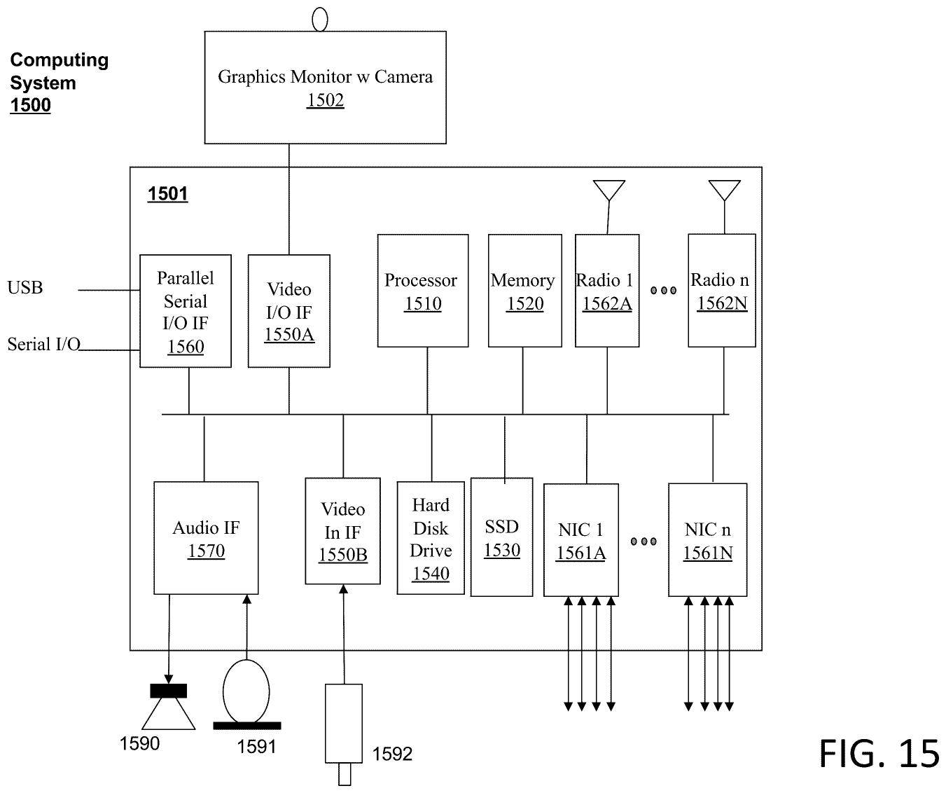

Referring now to FIG. 15, a block diagram of a computing system 1500 is shown that can execute the software instructions for the LLM support computer system. The computing system 1500 can be an instance of the one or more servers executing stored software instructions to perform the functional processes described herein. The computing system 1500 can also be an instance of a plurality of instances of the client computers in the wide area network executing stored software instructions to perform the functional processes described herein of a client computer to provide and display a web browser with the various window viewers described herein.

In one embodiment, the computing system 1500 can include a computer 1501 coupled in communication with a graphics monitor 1502 with or without a microphone. The computer 1501 can further be coupled to a loudspeaker 1590, a microphone 1591, and a camera 1592 in a service area with audio video devices. In accordance with one embodiment, the computer 1501 can include one or more processors 1510, memory 1520; one or more storage drives (e.g., solid state drive, hard disk drive) 1530,1540; a video input/output interface 1550A; a video input interface 1550B; a parallel/serial input/output data interface 1560; a plurality of network interfaces 1561A-1561N; a plurality of radio transmitter/receivers (transceivers) 1562A-1562N; and an audio interface 1570. The graphics monitor 1502 can be coupled in communication with the video input/output interface 1550A. The camera 1592 can be coupled in communication with the video input interface 1550B. The loudspeaker 1590 and microphone 1591 can be coupled in communication with the audio interface 1570. The camera 1592 can be used to view one or more audio-visual devices in a service area, such as the monitor 1502. The loudspeaker 1590 can be used to communicate out to a user in the service area while the microphone 1591 can be used to receive communications from the user in the service area.

The data interface 1560 can provide wired data connections, such as one or more universal serial bus (USB) interfaces and/or one or more serial input/output interfaces (e.g., RS232). The data interface 1560 can also provide a parallel data interface. The plurality of radio transmitter/receivers (transceivers) 1562A-1562N can provide wireless data connections such as over WIFI, Bluetooth, and/or cellular. The one or more audio video devices can use the wireless data connections or the wired data connections to communicate with the computer 1501.

The computer 1501 can be an edge computer that provides for remote logins and remote virtual sessions through one or more of the plurality of network interfaces 1561A-1561N. Additionally, each of the network interfaces support one or more network connections. Network interfaces can be virtual interfaces and also be logically separated from other virtual interfaces. One or more of the plurality of network interfaces 1561A-1561N can be used to make network connections between client computers and server computers.

One or more computing systems 1500 and/or one or more computers 1501 (or computer servers) can be used to perform some or all of the processes disclosed herein. The software instructions that performs the functionality of servers and devices are stored in the storage device 1530,1540 and loaded into memory 1520 when being executed by the processor 1510.

In one embodiment, the processor 1510 executes instructions residing on a machine-readable medium, such as the hard disk drive 1530,1540, a removable medium (e.g., a compact disk 1599, a magnetic tape, etc.), or a combination of both. In a server, the video interfaces 1550A-1550B can include a plurality of graphical processing units (GPUs) that are used to execute instructions to provide the neural network nodes for the AI neural network in order to perform the functions of the disclosed embodiments. The instructions can be loaded from the machine-readable medium into the memory 1520, which can include Random Access Memory (RAM), dynamic RAM (DRAM), etc. The processor 1510,1550A-1550B can retrieve the instructions from the memory 1520 and execute the instructions to perform operations described herein.

Note that any or all of the components and the associated hardware illustrated in FIG. 15 can be used in various embodiments of a computer system 1500. It should be appreciated that other configurations of the computer system 1500 can include more or less devices than those shown in FIG. 15.

There are a number of advantages to the disclosed embodiments. The Enterprise AI software provides a validated AI platform that has been purpose-built to extract predictive and prescriptive insights from unstructured textual, sensor, and procedural data in the automotive aftermarket and service business. Natural language processing (NLP) and domain expertise in the software enables industry leading companies to leverage previously unused data to increase aftersales revenue, empower quality management, drive product innovation, and support data-driven decision-making strategies.

While certain exemplary embodiments have been described and shown in the accompanying drawings, it is to be understood that such embodiments are merely illustrative of and not restrictive on the disclosed embodiments, and that the disclosed embodiments are not limited to the specific constructions and arrangements shown and described, since various other modifications may occur to those ordinarily skilled in the art.

When implemented in software, the elements of the embodiments of the invention are essentially the code segments to perform the necessary tasks. The program or code segments can be stored in a processor readable medium to be read out by a processor for execution. The code segments can be downloaded into a processor readable medium via computer networks such as the Internet, Intranet, etc. Alternatively, the code segments (instructions) can be stored in a processor readable medium external to or internal to a computer and in communication with a processor for execution. The processor readable medium may include any medium that can store information. Examples of the processor readable storage medium include an electronic circuit, a semiconductor memory device, a random-access memory (RAM), a read only memory (ROM), a flash memory, an erasable programmable read only memory (EPROM), a floppy diskette, a CD-ROM, an optical disk, a solid-state storage drive (SSD), a magnetic hard disk, etc.

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by patented claims that follow below.

1. A method for communicating with a service provider using language-based communication and one or more artificial intelligence (AI) models, the method comprising:
receiving an input prompt requesting domain specific information regarding servicing equipment within an industry;
determining an initial output response using an industry specific large language machine learning model, wherein the industry specific large language machine learning model is periodically and dynamically fined tuned with an industry specific language database; and
outputting the initial output response to an interface.

2. The method of claim 1, wherein:
the interface is an application programmable interface.

3. The method of claim 1, further comprising:
generating follow up questions based on a prompt, the initial output response, and the industry specific large language machine learning model; and
outputting follow up questions to the interface.

4. The method of claim 1, wherein:
the input prompt is provided by a user; and
the interface is accessible to the user to receive the initial output response.

5. The method of claim 1, wherein:
the interface is an output device accessible to a user.

6. The method of claim 5, wherein:
the output device is a display device; and
the initial output response is displayed to the user on the display device.

7. (canceled)

8. A system for analyzing language-based prompts related to servicing equipment, the system comprising:
a vector service database storing word embedding vectors associated with selected service data of equipment;
a large language tasks module coupled in communication with the vector service database and an interface, the large language tasks module to receive one or more input prompts from the interface, the large language tasks module having industry specific tasks including questions and answer tasks, named entity recognition, classification tasks, and machine translations tasks, the large language tasks module receives the one or more input prompts, performs intent discovery, generates an updated prompt request based on the one or more input prompts;
a fine-tuned large language AI model coupled in communication with the large language tasks module, the fine-tuned large language AI model receives the updated prompt request and process the updated prompt request and generates an output response based on the updated prompt request;
an output processing module coupled in communication with the fine-tuned large language AI model to receive the output response, parsing the output response, reflects the one or more input prompts, adds or updates missing context, and generates an overall usable output response; and
a vector services module coupled in communication with the large language tasks module and the vector service database, the vector services module receives service data, recognizes text in the service data and embeds the text with the service data, and writes the service data as selected service data into the vector service database, the vector services module further retrieves a semantically similar vector and associated index into the service data based on the updated prompt request.

9. The system of claim 8, wherein the equipment is a vehicle.

10. The system of claim 9, wherein the selected service data of the vehicle includes one or more of NHTSA complaints, NHTSA technical service bulletins, NHTSA recalls, prior repair orders of the equipment, technician documents, and technical service manuals.

11. The system of claim 8, wherein the named entity recognition includes one or more of a symptom component, a symptom, a failure component, a failure, a repair component, or a repair.

12. The system of claim 8, wherein the classification tasks include one or more of a symptom component, a symptom, a failure component, a failure, a repair component, a repair, a symptom to repair correlation, a symptom to failure correlation, top symptoms, top repairs.

13. A method for generating insights from one or more unstructured domain specific text datasets, the method comprising:
embedding unstructured domain specific text into a vector;
storing the vector into a vector database;
querying the vector database with a query vector in order to retrieve relevant documents related to the query vector;
transforming the retrieved relevant documents into a summary using one or more domain specific system prompts; and
fine-tuning a large language machine learning model based on domain specific data to improve accuracy and relevance of the summary with domain specific texts.
